(19) United States
(12) Patent Application Publication
(10) Pub. No.: US 2007/0257213 A1
(43) Pub. Date: Nov. 8, 2007

(54) Logistic station and detection device

(75) Inventors: Chang-Liang Huang, Chiayi County (TW); Yuan-Hsing Lin, Hsinchu County (TW)

Correspondence Address: BIRCH STEWART KOLASCH & BIRCH, PO BOX 747, FALLS CHURCH, VA, 22040-0747, US

(73) Assignee: Powerchip Semiconductor Corp.

(21) Appl. No.: 11/730,725

(22) Filed: Apr. 3, 2007

(30) Foreign Application Priority Data
Apr. 20, 2006 (TW) 95114101

(51) Int. Cl. G01N 21/86; G01B 11/14

(52) U.S. Cl. 250/559.29; 356/614; 356/621

(57) ABSTRACT

A logistic station comprises a plurality of objects having a first status and a second status and a detection device used for detecting the status of the objects. The detection device comprises a pallet having a plurality of first supporting portions and a first sensor. The objects are detachably disposed on the first supporting portions of the pallet. A first reference position and a first predetermined position are configured in the pallet with respect to the first supporting portions thereof. The first sensor transmits a first signal to the first predetermined position to detect whether objects having the second status.

### BACKGROUND OF THE INVENTION

1. Field of the Invention

The invention relates to a logistic station, and in particular to a logistic station and a detection device for detecting a spoiled wafer.

2. Description of the Related Art

In FIG. 1, a plurality of wafers W supported by a pallet 10′ is detected by a conventional detection device E. The detection device E disposed next to the pallet 10′ comprises a sensor e1 and a reflector e2. The sensor e1 emits a horizontal signal S0 to the reflector e2, and the reflector e2 reflects the horizontal signal S0 to the sensor e1.

When the wafers W are removed from the pallet 10′ and no spoiled wafer exist, the sensor e1 emits the horizontal signal S0 to the reflector e2, and the reflector e2 reflects the horizontal signal S0 to the sensor e1. When the wafers W are removed from the pallet 10′ and a smaller spoiled wafer W′ exists (not located in the path of the horizontal signal S0), transmission of the horizontal signal S0 is not blocked by the spoiled wafer W′, horizontal signal S0 reaches the reflector e2, and the reflected horizontal signal S0 is transmitted to the sensor e1.

### BRIEF SUMMARY OF THE INVENTION

To achieve the described purposes, the invention provides a logistic station for detection any broken objects. The logistic station comprises a plurality of objects and a detection device. The objects have a first status and a second status. The detection device for detecting the objects comprises a pallet and a first sensor. The pallet comprises a plurality of first supporting portions, a first reference position and a first predetermined position. The objects detachably disposed on the first supporting portion located at the first supporting portions have a first status and a second status, and the first reference position and the first predetermined position are defined with respect to the first supporting portions. The first sensor emits a first signal traveling sequentially through the first reference position and the first predetermined position. When the objects are removed from the first supporting portions and each object has the first status, the first signal passes through the first reference position and reaches the first predetermined position. When the objects are removed from the first supporting portions and at least one of the objects has the second status, transmission of the first signal is blocked by the broken object and the first signal fails to pass through the first reference position to the first predetermined position.

The first reference position is the location of at least one of the objects supported by the first supporting portions.

The logistic station further comprises a plurality of second supporting portions. The objects are detachably disposed on the first supporting portion and the second supporting portions, and the first reference position is the location of at least one of the objects supported by the first supporting portions and the second supporting portions. The first reference position is located between the first supporting portions and the second supporting portions.

The logistic station further comprises a first reflector used to reflect the first signal emitted from the first sensor back to the first sensor. The first predetermined position is the location of the first reflector.

The logistic station further comprises a second sensor and the first supporting portions of the pallet further comprise a second reference position and a second predetermined position. The second sensor emits a second signal traveling sequentially through the second reference position and the second predetermined position.

When the objects are removed from the first supporting portions and each object has the first status, the second signal passes through the second reference position and reaches the second predetermined position. When the objects are removed from the first supporting portions and at least one of the objects has the second status, transmission of the first signal is blocked by the broken object and the first signal fails to pass through the first reference position to the first predetermined position.

The second reference position is the location of at least one of the objects supported by the first supporting portions.

The logistic station further comprises a plurality of third supporting portions. The objects are detachably disposed on the first supporting portion and the third supporting portions, and the second reference position is the location of at least one of the objects supported by the first supporting portions and the third supporting portions.

The second reference position is located between the first supporting portions and the third supporting portions.

The logistic station further comprises a second reflector used to reflect the second signal emitted from the second sensor back to the second sensor. The second predetermined position is located at the second reflector.

The objects comprise a wafer, and the first status comprises an intact wafer, and the second status comprises the spoiled wafer.

The invention further can be incorporated with another sensor and another reflector, to detect the existence of the spoiled wafer via a horizontal signal.

A detailed description is given in the following embodiments with reference to the accompanying drawings.

### BRIEF DESCRIPTION OF THE DRAWINGS

The invention can be more fully understood by reading the subsequent detailed description and examples with references made to the accompanying drawings, wherein:

FIG. 1 is a schematic view of a conventional detection device (E), wherein the detection device (E) detects the status of a plurality of wafers (W) located on a pallet (10′);

FIG. 2A is a perspective view of a logistic station (V), wherein the logistic station (V) comprises a plurality of wafers (W), a detection device (M) and a robotic arm (N);

FIG. 2B is a perspective view of the logistic station (V);

FIG. 3A is a schematic view of an intact wafer (W) disposed on the pallet (10) inspected along a direction (y-y) of the FIG. 2A;

FIG. 3B is a schematic view of a spoiled wafer (W′) disposed on the pallet (10) inspected along a direction (y-y) of the FIG. 2A;

FIG. 4 is a side view of the detection device (M) when performing the detection process;

FIG. 5 is a schematic view of the detection device (M) when performing the detection process; and

FIG. 6 is a top view of the detection device (M) of FIG. 5.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

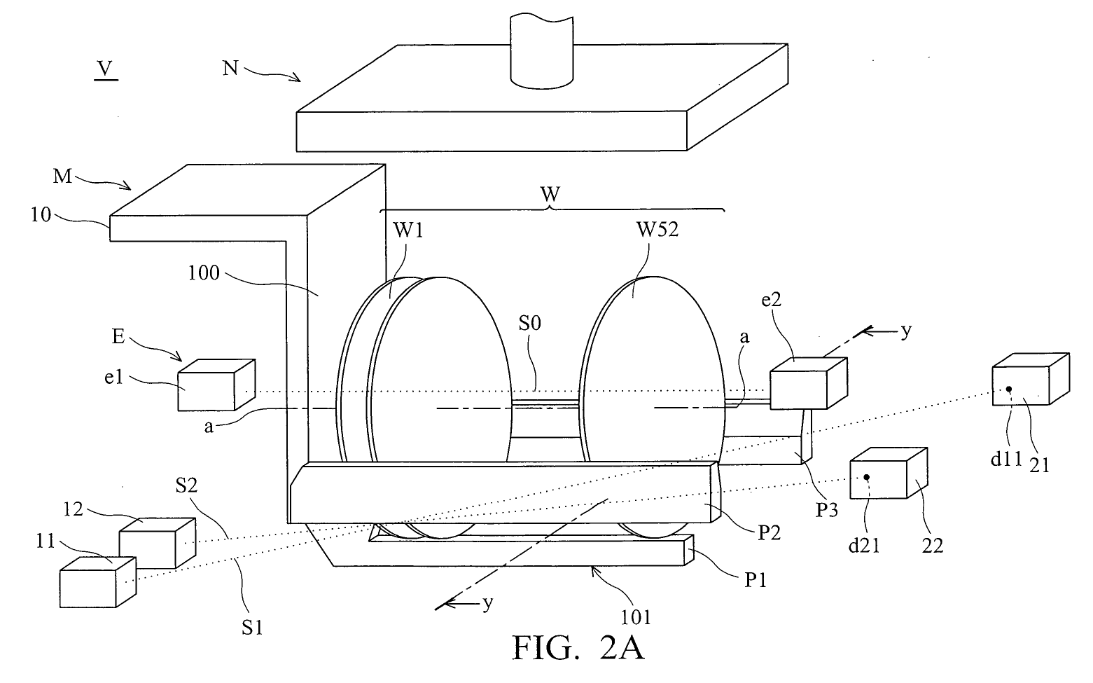

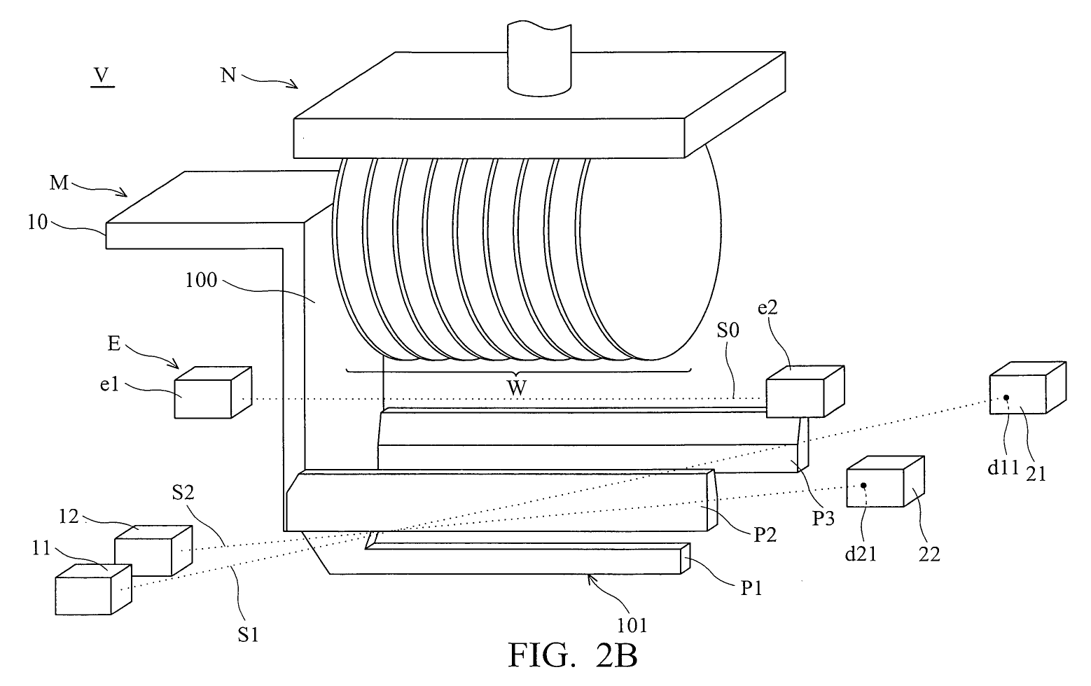

In FIGS. 2A and 2B, a logistic station V of the invention comprises a plurality of objects W having a first status (intact) and a second status (spoiled), a robotic arm N, and a detection device M for detecting the objects W. The robotic arm N moves the objects W in or removes the objects W from the detection device M. In this embodiment, the objects W are wafers.

The detection device M comprises a pallet 10, a first sensor 11, a second sensor 12, a first reflector 21 and a second reflector 22. The wafers W disposed on the pallet 10 are arranged along an axis a-a. The first sensor 11 and the first reflector 21 form a pair, and the second sensor 12 and the second reflector 22 form a pair.

Without blockage or hindrance by the wafers, the first sensor 11 emits first signal S1, e.g. X-beam, to the first reflector 21, and the first reflector 21 reflects the first signal S1 to the first sensor 11. In addition, the second sensor 12 emits second signal S2 to the second reflector 22, and the second reflector 22 reflects the second signal S2 to the second sensor 12. In this embodiment, the first signal S1 is different from the second signal S2 and neither are parallel to the axis a-a, and the first signal S1 and the second signal S2 are not parallel and do not intersect each other.

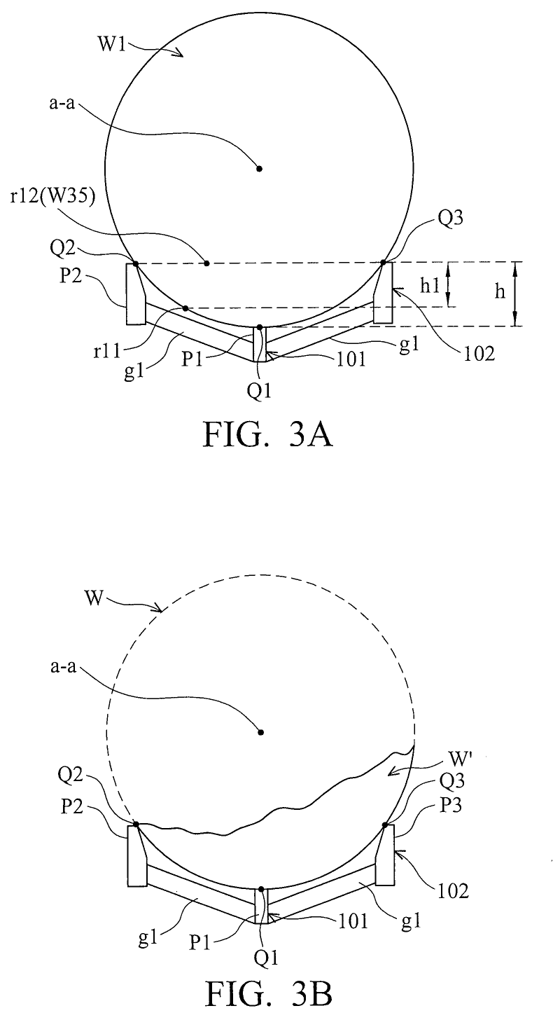

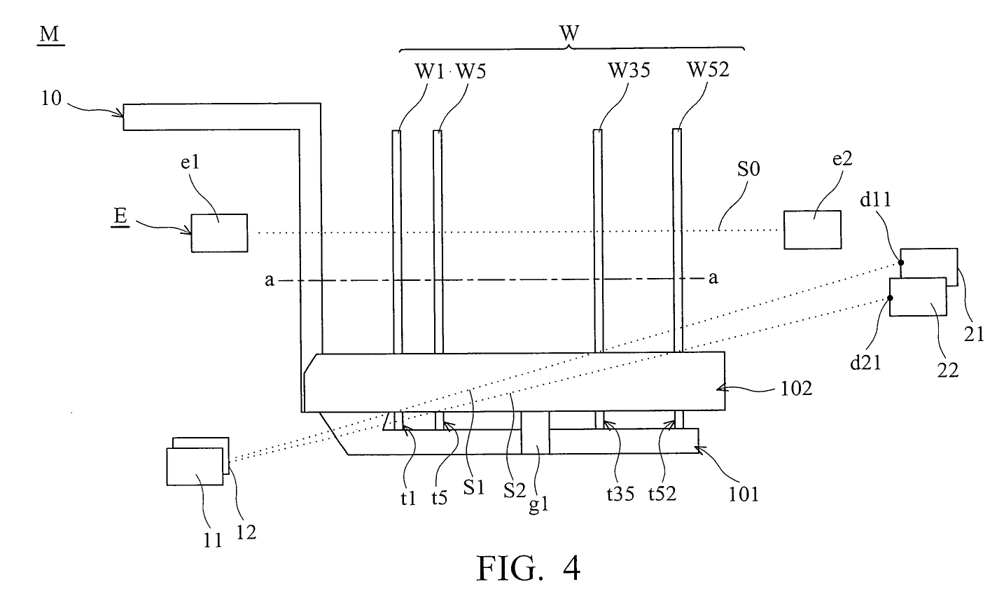

In FIG. 3A, an intact wafer W is disposed on the pallet 10 inspected along a direction y-y of the FIG. 2A. In FIG. 3B, a spoiled wafer W′ is disposed on the pallet 10 inspected along a direction y-y of the FIG. 2A. FIG. 4 is a side view of the detection device M when performing the detection process.

The pallet 10 comprises a body 100 and a bottom plate 101 extending from one side of the body 100. The wafers W are detachably supported by the bottom plate 101 of the pallet 10. The bottom plate 101 comprises two wing plates g1, a plurality of spaced first supporting portions P1, a plurality of spaced second supporting portions P2 and a plurality of spaced third supporting portions P3. The second and third supporting portions P2 and P3 are symmetrical with respect to the first supporting portions P1, and the first and second supporting portions P1 and P2 and the first and third supporting portions P1 and P3 are connected by the wing plates g1. The wafers W, detachably supported by the first, second and third supporting portions. P1, P2 and P3, respectively contact the first, second and third supporting portions P1, P2 and P3 at three positions Q1, Q2 and Q3, and the contact position Q1 is the lowest with respect to the contact positions Q2 and Q3.

A height difference h is formed between the distance measured from the contact position Q1 of the first supporting portion P1 to the contact position Q2 of the second supporting portion P2 and the distance measured from the contact position Q1 of the first supporting portion P1 to the contact position Q3 of the third supporting portion P3. In this embodiment, the positions Q1, Q2 and Q3 are dots, i.e., the relationship between the supported wafers W and the first, second and third supporting portions P1, P2 and P3 is dot contact.

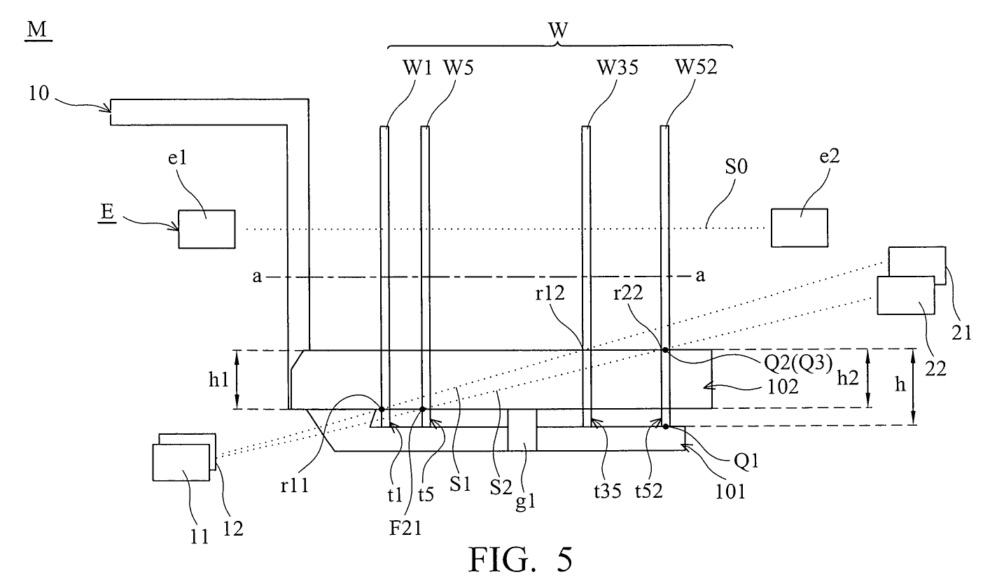

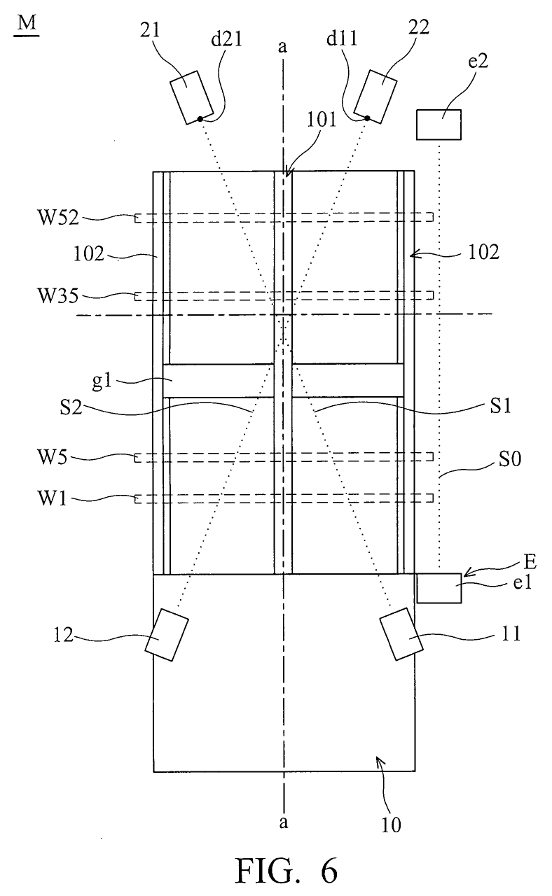

In FIGS. 3A and 5, fifty-two pieces of wafers W are assumed to be supported by the pallet 10. The 1^{st}, 5^{th}, 35^{th} and 52^{nd} wafers W1, W5, W35 and W52, for example, are respectively located in the 1^{st}, 5^{th}, 35^{th} and 52^{nd} slots t1, t5, t35 and t52. The 1^{st} and 52^{nd} slots t1 and t52 are the nearest and far slots with respect to the body 100 of the pallet 10, and the 5^{th} and 35^{th} slots t5 and t35 are located between the 1^{st} and 52^{nd} slots t1 and t52.

A first reference position r11, a second reference position r21, a first predetermined position d11 and a second predetermined position d21 are defined with respect to the first supporting portions P1 of the pallet 10.

The first reference position r11 located between the first and second supporting portions P1 and P2 is relatively defined at the flange of 1^{st} wafer W1 located in the 1^{st} slot t1 and supported by the first, second and third supporting portions P1, P2 and P3. The first predetermined position d11 is relatively defined at an incident region of the first signal S1 entering the first reflector 21. A first auxiliary reference position r12 located between the first reference position r11 and the first predetermined position d11 is defined at the 35^{th} wafer W35 located in the 35^{th} slot t35 and has the same height with respect to the second and third supporting portions P2 and P3. That is to say, a height difference h1 measured between the first reference position r11 and the first auxiliary reference position r12 is smaller than the height difference h measured between the first and second supporting portions P1 and P2 or the first and third supporting portions P1 and P3.

In this embodiment, the 1^{st}-35^{th} wafers W1-W35 are round, but the supported object can have various different shapes, and the first reference position is defined at one of the adjacent supporting points (e.g., the first supporting portion P1) or/and the second supporting portion P2) and located between the adjacent supporting points (e.g., the first supporting portion P1 and the second supporting portion P2). Note that the first auxiliary reference position is defined between the adjacent supporting points.

When the 1^{st}-35^{th} wafers W1-W35 are removed from the first, second and third supporting portions P1, P2 and P3 of the bottom plate 101 and each 1^{st}-35^{th} wafer W1-W35 has the first status (intact), the first signal S1 passes through the first reference position r11 and reaches the first predetermined position d11. When the 1^{st}-35^{th} wafers W1-W35 are removed from the first, second and third supporting portions P1, P2 and P3 of the bottom plate 101 and at least one of the 1^{st}-35^{th} wafers W1-W35 has the second status (spoiled), transmission of the first signal S1 is blocked by the spoiled wafer W′ and the first signal S1 fails to pass through the first reference position r11 to the first predetermined position d11. Thus, any broken pieces of wafer, regardless of shape or size, located at the first, second and third supporting portions P1, P2 and P3 can be detected by the first signal S1.

The second reference position r21 located between the first and second supporting portions P1 and P2 is relatively defined at the flange of 5^{th} wafer W5 located in the 5^{th} slot t5 and supported by the first, second and third supporting portions P1, P2 and P3. The second predetermined position d21 is relatively defined at an incident region of the second signal S2 entering the second reflector 22.

In FIG. 5, a second auxiliary reference position r22 located between the second reference position r21 and the second predetermined position d21 is defined at the 52^{st} wafer W52 located in the 52^{st} slot t52 and has the same height with respect to the second and third supporting portions P2 and P3. That is to say, a height difference h2 measured between the second reference position r21 and the second auxiliary reference position r22 is smaller than the height difference h measured between the first and second supporting portions P1 and P2 or the first and third supporting portions P1 and P3.

In this embodiment, the 5^{th}-52^{nd} wafers W5-W52 are round, but the supported object can be formed into various different shapes, and the second reference position is defined at one of the adjacent supporting points (e.g., the first supporting portion P1 or/and the second supporting portion P2) and located between the adjacent supporting points (e.g., the first supporting portion P1 and the second supporting portion P2). Note that the second auxiliary reference position is defined between the adjacent supporting points.

When the 5^{th}-52^{nd} wafers W5-W52 are removed from the first, second and third supporting portions P1, P2 and P3 of the bottom plate 101 and each 5^{th}-52^{nd} wafer W5-W52 has the first status (intact), the second signal S2 passes through the second reference position r21 and reaches the second predetermined position d21. When the 5^{th}-52^{nd} wafers W5-W52 are removed from the first, second and third supporting portions P1, P2 and P3 of the bottom plate 101 and at least one of the 5^{th}-52^{nd} wafers W5-W52 has the second status (spoiled), transmission of the second signal S2 is blocked by the spoiled wafer W′ and the second signal S2 fails to pass through the second reference position r21 to the second predetermined position d21. Thus, any broken pieces of wafer, regardless of shape or size, located at the first, second and third supporting portions P1, P2 and P3 can be detected by the second signal S2.

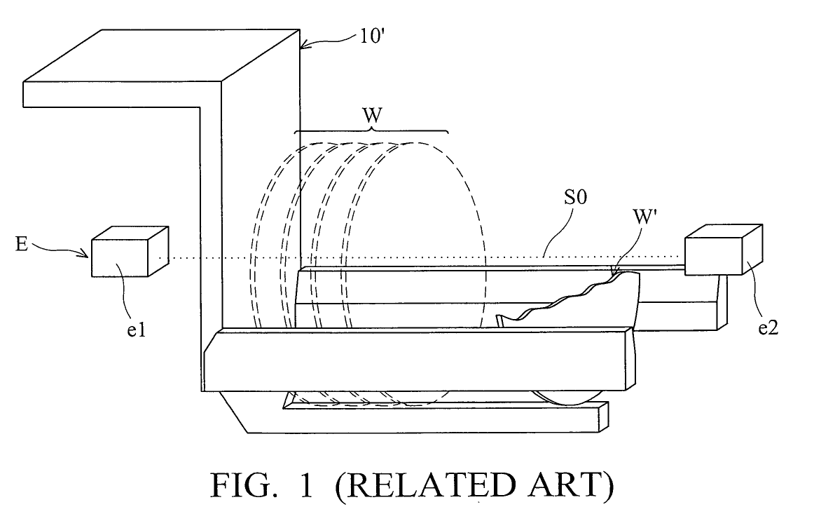

Note that the sensor e1 and the reflector e2 of the conventional detection device E of FIG. 1 can be incorporated into the logistic station V, and the horizontal signal S0 can be used to detect the existence of the spoiled wafer.

While the invention has been described by way of example and in terms of the preferred embodiments, it is to be understood that the invention is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A detection device for detecting a first status and a second status from a plurality of objects, the detection device comprising:
a pallet comprising a plurality of first supporting portions, a first reference position and a first predetermined position, wherein the objects detachably disposed on the first supporting portion are located at the first supporting portions having the first status and the second status, and the first reference position and the first predetermined position are defined with respect to the first supporting portions; and
a first sensor emitting a first signal traveling sequentially through the first reference position and the first predetermined position;
when the objects are removed from the first supporting portions and each object has the first status, the first signal passes through the first reference position and reaches the first predetermined position; when the objects are removed from the first supporting portions and at least one of the objects has the second status, the first signal fails to pass through the first reference position and reach the first predetermined position.

2. The detection device as claimed in claim 1, wherein the first reference position is the location of at least one of the objects supported by the first supporting portions.

3. The detection device as claimed in claim 1 further comprising a plurality of second supporting portions, wherein the objects are detachably disposed on the first supporting portion and the second supporting portions, and the first reference position is the location of at least one of the objects supported by the first supporting portions and the second supporting portions.

4. The detection device as claimed in claim 3, wherein the first reference position is located between the first supporting portions and the second supporting portions.

5. The detection device as claimed in claim 1 further comprising a first reflector reflecting the first signal emitted from the first sensor to the first sensor.

6. The detection device as claimed in claim 5, wherein the first predetermined position is located at the first reflector.

7. The detection device as claimed in claim 1 further comprising a second sensor and the first supporting portions of the pallet further comprising a second reference position and a second predetermined position, wherein the second sensor emits a second signal traveling sequentially through the second reference position and the second predetermined position;
when the objects are removed from the first supporting portions and each object has the first status, the second signal passes through the second reference position and reaches the second predetermined position; when the objects are removed from the first supporting portions and at least one of the objects has the second status, the first signal fails to pass through the first reference position and reach the first predetermined position.

8. The detection device as claimed in claim 7, wherein the second reference position is the location of at least one of the objects supported by the first supporting portions.

9. The detection device as claimed in claim 7 further comprising a plurality of third supporting portions, wherein the objects are detachably disposed on the first supporting portion and the third supporting portions, and the second reference position is the location of at least one of the objects supported by the first supporting portions and the third supporting portions.

10. The detection device as claimed in claim 9, wherein the second reference position is located between the first supporting portions and the third supporting portions.

11. The detection device as claimed in claim 7 further comprising a second reflector reflecting the second signal emitted from the second sensor to the second sensor.

12. The detection device as claimed in claim 11, wherein the second predetermined position is located at the second reflector.

13. A logistic station, comprising:
a plurality of objects having a first status and a second status;
a detection device for detecting the objects, the detection device comprising:
a pallet comprising a plurality of first supporting portions, a first reference position and a first predetermined position, wherein the objects detachably disposed on the first supporting portion are located at the first supporting portions having the first status and the second status, and the first reference position and the first predetermined position are defined with respect to the first supporting portions; and
a first sensor emitting a first signal traveling sequentially through the first reference position and the first predetermined position;
when the objects are removed from the first supporting portions and each object has the first status, the first signal passes through the first reference position and reaches the first predetermined position; when the objects are removed from the first supporting portions and at least one of the objects has the second status, the first signal fails to pass through the first reference position and reach the first predetermined position.

14. The logistic station as claimed in claim 13, wherein the first reference position is the location of at least one of the objects supported by the first supporting portions.

15. The logistic station as claimed in claim 13 further comprising a plurality of second supporting portions, wherein the objects are detachably disposed on the first supporting portion and the second supporting portions, and the first reference position is the location of at least one of the objects supported by the first supporting portions and the second supporting portions.

16. The logistic station as claimed in claim 15, wherein the first reference position is located between the first supporting portions and the second supporting portions.

17. The logistic station as claimed in claim 13 further comprising a first reflector reflecting the first signal emitted from the first sensor to the first sensor.

18. The logistic station as claimed in claim 17, wherein the first predetermined position is located at the first reflector.

19. The logistic station as claimed in claim 13 further comprising a second sensor and the first supporting portions of the pallet further comprising a second reference position and a second predetermined position, wherein the second sensor emits a second signal traveling sequentially through the second reference position and the second predetermined position;
when the objects are removed from the first supporting portions and each object has the first status, the second signal passes through the second reference position and reaches the second predetermined position; when the objects are removed from the first supporting portions and at least one of the objects has the second status, the first signal fails to pass through the first reference position and reach the first predetermined position.

20. The logistic station as claimed in claim 19, wherein the second reference position is the location of at least one of the objects supported by the first supporting portions.

21. The logistic station as claimed in claim 19 further comprising a plurality of third supporting portions, wherein the objects are detachably disposed on the first supporting portion and the third supporting portions, and the second reference position is the location of at least one of the objects supported by the first supporting portions and the third supporting portions.

22. The logistic station as claimed in claim 21, wherein the second reference position is located between the first supporting portions and the third supporting portions.

23. The logistic station as claimed in claim 19 further comprising a second reflector reflecting the second signal emitted from the second sensor to the second sensor.

24. The logistic station as claimed in claim 23, wherein the second predetermined position is located at the second reflector.

25. The logistic station as claimed in claim 13, wherein the objects comprise a wafer, and the first status comprises an intact wafer, and the second status comprises the spoiled wafer.
